(19) United States
(12) Patent Application Publication
(10) Pub. No.: US 2011/0201763 A1
(43) Pub. Date: Aug. 18, 2011

(54) THERMOSETTING RESIN COMPOSITION FOR OPTICAL-SEMICONDUCTOR ELEMENT ENCAPSULATION AND CURED MATERIAL THEREOF, AND OPTICAL-SEMICONDUCTOR DEVICE OBTAINED USING THE SAME

(75) Inventors: Hiroshi NORO, Osaka (JP); Takahiro UCHIDA, Osaka (JP); Chisato GOTO, Osaka (JP)

(73) Assignee: NITTO DENKO CORPORATION, Osaka (JP)

(21) Appl. No.: 13/021,845

(22) Filed: Feb. 7, 2011

(30) Foreign Application Priority Data
Feb. 18, 2010 (JP) 2010-034131

(51) Int. Cl. C08L 63/06

(52) U.S. Cl. 525/476

(57) ABSTRACT

The present invention relates to a thermosetting resin composition for optical-semiconductor element encapsulation, the thermosetting resin composition including the following ingredients (A) to (D): (A) an epoxy group-containing siloxane compound represented by the following general formula (1) in which R₁ is a monovalent hydrocarbon group having 1 to 10 carbon atoms, R₂ is a divalent hydrocarbon group having 1 to 20 carbon atoms and may contain an oxygen atom for ether formulation or ester formulation inside thereof, and n is an integer of 0 to 20; (B) an acid anhydride curing agent; (C) a thermally condensable organosiloxane; and (D) a curing accelerator.

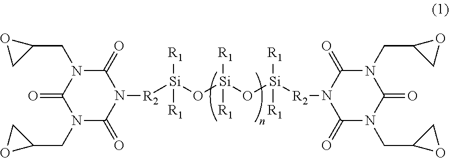

### FIELD OF THE INVENTION

The present invention relates to a thermosetting resin composition for optical-semiconductor element encapsulation to be used for encapsulating optical-semiconductor elements such as light-emitting elements and light-receiving sensors and relates to a cured material thereof and an optical-semiconductor device obtained using the same.

### BACKGROUND OF THE INVENTION

Hitherto, as a resin composition for encapsulating optical-semiconductor elements such as light-emitting elements and light-receiving sensors, a cured product of the composition to be a resin-encapsulating part is required to have transparency, so that an epoxy resin composition obtained using an epoxy resin such as a bisphenol A-type epoxy resin and a curing agent such as an acid anhydride has been commonly used.

However, in recent years, luminance has been heightened in light-emitting elements and use of light-receiving sensors has become popularized in in-vehicle applications and as pickups for blu-ray (registered trademark) disk-compatible devices. Accordingly, a thermosetting resin composition for encapsulation having a higher thermal discoloration resistance and light resistance as before has been required.

As a method for improving heat resistance or light resistance in the above epoxy resin composition for optical-semiconductor devices, there have been hitherto used: a method for elevating glass transition temperature (hereinafter sometimes referred to as “Tg”) of a cured material obtained using a polyfunctional epoxy resin; and a method for suppressing light deterioration by light absorption using an alicyclic epoxy resin (e.g., see Patent Documents 1 and 2).

On the other hand, for the purpose of obtaining a higher light resistance than that of an epoxy resin, recently, a thermosetting resin composition for optical-semiconductors using an epoxy-modified silicone resin and a composite encapsulating material in which an epoxy resin composition and a silicone resin are mixed have been highlighted as highly light-resistant encapsulating resins (e.g., see Patent Documents 3 and 4).
Patent Document 1: JP-A-2002-226551
Patent Document 2 JP-A-2003-277473
Patent Document 3 JP-A-2002-324920
Patent Document 4 JP-A-2006-213762

### SUMMARY OF THE INVENTION

However, in general, in the case where a mixture of a polyfunctional epoxy resin or an alicyclic epoxy resin and a silicone resin is used as a thermosetting resin composition for the purpose of improving heat resistance and light resistance as above, decrease in strength of a resin molded product (cured material) is caused, so that there is a concern that a problem of crack formation owing to heat shrinkage may arise in an encapsulating resin (cured material), for example, at solder reflow or during tests such as a temperature cycle of an optical-semiconductor device obtained by encapsulation with the resin.

The invention has been devised in consideration of such a situation and an object thereof is to provide a thermosetting resin composition for optical-semiconductor element encapsulation, which suppresses resin crack formation at the production of an optical-semiconductor device and is excellent in low stress properties and light resistance, and a cured material thereof, as well as an optical-semiconductor device using the same.

Namely, the present invention relates to the following items (1) to (7).

(1) A thermosetting resin composition for optical-semiconductor element encapsulation, the thermosetting resin composition including the following ingredients (A) to (D):

(A) an epoxy group-containing siloxane compound represented by the following general formula (1):

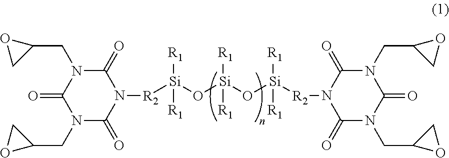

in which R₁ is a monovalent hydrocarbon group having 1 to 10 carbon atoms, R₂ is a divalent hydrocarbon group having 1 to 20 carbon atoms and may contain an oxygen atom for ether formulation or ester formulation inside thereof, and n is an integer of 0 to 20;

(B) an acid anhydride curing agent;

(C) a thermally condensable organosiloxane; and

(D) a curing accelerator.

(2) The thermosetting resin composition for optical-semiconductor element encapsulation according to (1), which further contains the following ingredient (E) in addition to the ingredients (A) to (D):

(E) an epoxy resin having two or more epoxy groups in one molecule thereof, other than the ingredient (A).

(3) The thermosetting resin composition for optical-semiconductor element encapsulation according to (1) or (2), in which a content of the ingredient (B) is set so that an amount of acid anhydride groups in the ingredient (B) is in the range of 0.5 to 1.5 equivalents per one equivalent of the epoxy groups in the whole thermosetting resin composition.

(4) The thermosetting resin composition for optical-semiconductor element encapsulation according to any one of (1) to (3), in which the ingredient (C) is a polyorganosiloxane represented by the following general formula (3):

Rₘ(OR¹)ₙSiO_{(4-m-n)/2} (3)

in which R is a substituted or unsubstituted, saturated monovalent hydrocarbon group having 1 to 18 carbon atoms and Rs may be the same or different, R¹ is a hydrogen atom or an alkyl group having 1 to 6 carbon atoms and R¹s may be the same or different, and m and n are each an integer of 0 to 3.

(5) A cured material of the thermosetting resin composition for optical-semiconductor element encapsulation, the cured material being obtained by heat-curing the thermosetting resin composition for optical-semiconductor element encapsulation according to any one of (1) to (4).

(6) An optical-semiconductor device obtained by resin-encapsulating an optical-semiconductor element using the thermosetting resin composition for optical-semiconductor element encapsulation according to any one of (1) to (4).

(7) An optical-semiconductor device obtained by resin-encapsulating an optical-semiconductor element using the cured material of the thermosetting resin composition for optical-semiconductor element encapsulation according to (5).

The present inventors have intensively investigated in order to obtain a thermosetting resin composition for optical-semiconductor element encapsulation, which effectively suppresses crack formation that may occur at the resin-encapsulation with an encapsulating material using a polyfunctional epoxy resin or an alicyclic epoxy resin and is excellent in low stress properties and light resistance. As a result, they have found that when the epoxy group-containing siloxane compound [ingredient (A)] represented by the above general formula (1) and the thermally condensable organosiloxane [ingredient (C)] are used in combination, excellent light resistance and heat resistance derived from the above organosiloxane are imparted in addition to the flexibility derived from the above epoxy group-containing siloxane compound and hence excellent reflow-cracking resistance and light resistance owing to an effect of improving the low stress properties are imparted by the synergistic effect realized by the combined use of both ingredients, achieving the desired purpose. Thus, they have reached the invention.

Thus, the invention lies on a thermosetting resin composition for optical-semiconductor element encapsulation, which includes the specific epoxy group-containing siloxane compound [ingredient (A)], the acid anhydride curing agent [ingredient (B)], the thermally condensable organosiloxane [ingredient (C)], and the curing accelerator [ingredient (D)]. Therefore, it becomes possible to form a transparent cured material maintaining a high glass transition temperature (Tg) and having excellent strength and flexibility and also one having excellent thermal discoloration resistance and light resistance is obtained. Accordingly, by resin-encapsulation of an optical-semiconductor element using the thermosetting resin composition, an optical-semiconductor device having a high reliability is obtained, which has both of reflow-cracking resistance and light resistance.

Furthermore, when an epoxy resin having two or more epoxy groups in one molecule thereof [ingredient (E)] other than the ingredient (A) is used in addition to the above individual ingredients, the reactivity with the curing agent can be easily controlled and control of the glass transition temperature (Tg) and elastic modulus of the cured material obtained can be easily conducted.

When the content of the above acid anhydride curing agent [ingredient (B)] is set so that the amount of acid anhydride groups in the acid anhydride curing agent [ingredient (B)] is in a specific range per one equivalent of the epoxy groups in the whole thermosetting resin composition, the curing rate of the thermosetting resin composition can be set at an appropriate rate and also it becomes possible to suppress a decrease in glass transition temperature (Tg) of the cured material and a decrease in moisture resistance thereof.

### DETAILED DESCRIPTION OF THE INVENTION

The thermosetting resin composition for optical-semiconductor element encapsulation (hereinafter sometimes referred to as “thermosetting resin composition”) of the invention is obtained using a specific epoxy group-containing siloxane compound [ingredient (A)], an acid anhydride curing agent [ingredient (B)], a thermally condensable organosiloxane [ingredient (C)], and a curing accelerator [ingredient (D)]. Usually, the composition is served as an encapsulating material in the form of liquid, powder or a tablet formed through tabletting from the powder.

The specific epoxy group-containing siloxane compound [ingredient (A)] is represented by the following general formula (1):

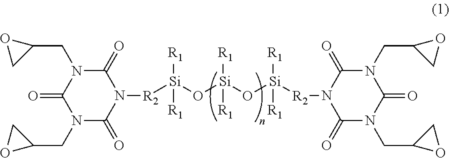

in which R₁ is a monovalent hydrocarbon group having 1 to 10 carbon atoms, R₂ is a divalent hydrocarbon group having 1 to 20 carbon atoms and may contain an oxygen atom for ether formulation or ester formulation inside thereof, and n is an integer of 0 to 20.

In the above formula (1), R₁ is a monovalent hydrocarbon group having 1 to 10 carbon atoms. Examples of such a hydrocarbon group include linear hydrocarbon groups such as methyl, ethyl, propyl, isopropyl, butyl, isobutyl, hexyl, octyl, isooctyl, and decyl groups, aliphatic hydrocarbon groups such as a cyclohexyl group, and aromatic hydrocarbon groups such as a phenyl group. These may be the same or different.

In the above formula (1), R₂ is a divalent hydrocarbon group having 1 to 20 carbon atoms and may contain an oxygen atom for ether formulation or ester formulation inside thereof. Examples of such a hydrocarbon group include methylene, ethylene, propylene, butylene, hexylene, octylene, and decylene groups. These may be the same or different from each other.

Furthermore, in the above formula (1), the number of repetitions n is an integer of 0 to 20. Preferred is an integer of 1 to 10 and especially preferred is an integer of 4 to 8.

The epoxy group-containing siloxane compound [ingredient (A)] preferably has an epoxy equivalent of 150 to 1000 g/eq. When the epoxy equivalent is too small, the linear siloxane bond is too short, so that there is a concern that a decrease in stress of the cured material obtained may be insufficient. Moreover, when the epoxy equivalent is too large, the linear siloxane bond is too long, so that there is a concern that reactivity and compatibility with other ingredients may be impaired.

The epoxy group-containing siloxane compound [ingredient (A)] may be, for example, liquid or solid at 25° C. In the case where the compound is solid, the softening point thereof is preferably 150° C. or lower, especially preferably 120° C. or lower from the standpoint of melt-mixing with the other blending ingredients.

The epoxy group-containing siloxane compound [ingredient (A)] represented by the above general formula (1) can be obtained, for example, by the reaction of a siloxane compound represented by the following general formula (2) with an N′,N″-diglycidyl isocyanurate compound having one double bond in one molecule thereof:

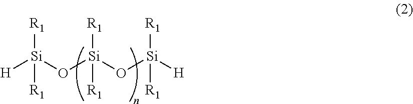

in which R₁ is a monovalent hydrocarbon group having 1 to 10 carbon atoms and n is an integer of 0 to 20.

As the N′,N″-diglycidyl isocyanurate compound having one double bond in one molecule thereof, N-allyl-N′,N″-diglycidyl isocyanurate is more preferably used from the standpoint of improvement in heat resistance. The R₁ and n in the above formula (2) correspond to those in the aforementioned formula (1).

Examples of the acid anhydride curing agent [ingredient (B)] to be used in combination with the above ingredient (A) include phthalic anhydride, maleic anhydride, trimellitic anhydride, pyromellitic anhydride, hexahydrophthalic anhydride, tetrahydrophthalic anhydride, methylnadic anhydride, nadic anhydride, glutaric anhydride, methylhexahydrophthalic anhydride, and methyltetrahydrophthalic anhydride. These may be used alone or in combination of two or more thereof. Of these acid anhydride curing agents, it is preferred to use phthalic anhydride, hexahydrophthalic anhydride, tetrahydrophthalic anhydride, and methylhexahydrophthalic anhydride alone or in combination of two or more thereof. Preferred acid anhydride curing agents [ingredient (B)] have a molecular weight of about 140 to 200 and are colorless or light-yellow acid anhydride curing agents.

The contents of the epoxy group-containing siloxane compound [ingredient (A)] and the acid anhydride curing agent [ingredient (B)] is set so that the amount of active groups (acid anhydride groups or hydroxyl groups) in the acid anhydride curing agent [ingredient (B)] which are capable of reacting with an epoxy group is preferably 0.5 to 1.5 equivalents, more preferably 0.7 to 1.2 equivalents, per one equivalent of the epoxy groups contained in the thermosetting resin composition containing the epoxy group-containing siloxane compound [ingredient (A)]. The reasons for this are as follows. In the case where the amount of the active groups is too small, there is a tendency that the thermosetting resin composition has a reduced curing rate and gives a cured material having a lowered glass transition temperature (Tg). In the case where the amount of the active groups is too large, moisture resistance tends to decrease.

Curing agents for epoxy resins, other than the acid anhydride curing agents described above, may be used as the acid anhydride curing agent [ingredient (B)] according to the purpose and use thereof. Examples of such other curing agents include phenol curing agents, amine curing agents, curing agents obtained by partly esterifying the acid anhydride curing agents with an alcohol, and carboxylic acid curing agents such as hexahydrophthalic acid, tetrahydrophthalic acid, and methylhexahydrophthalic acid. These may be used alone or a combination of the curing agent described above and a phenol curing agent may be used. For example, when a carboxylic acid curing agent is used in combination, the combined use can heighten the curing rate and can improve productivity. Also in the case where these curing agent are used, the content thereof may be the same as the content (equivalent ratio) in the case where the acid anhydride curing agent [ingredient (B)] shown above is used.

The thermally condensable organosiloxane [ingredient (C)] to be used in combination with the ingredient (A) and ingredient (B) may be any organosiloxane which is capable of melt-mixing with the resin ingredients, and use can be made of various polyorganosiloxanes, i.e., polyorganosiloxanes which are solid without solvent or liquid at room temperature (around 25° C.). Such an organosiloxane may be any organosiloxane capable of being evenly dispersed on the order of nanometer in the cured material of the thermosetting resin composition.

Examples of the above thermally condensable organosiloxane [ingredient (C)] include ones in which the siloxane units serving as a component thereof are represented by the following general formula (3):

Rₘ(OR¹)ₙSiO_{(4-m-n)/2} (3)

in which R is a substituted or unsubstituted, saturated monovalent hydrocarbon group having 1 to 18 carbon atoms and Rs may be the same or different, R¹ is a hydrogen atom or an alkyl group having 1 to 6 carbon atoms and R¹s may be the same or different, and m and n are each an integer of 0 to 3.

Examples thereof include polyorganosiloxanes which have at least one silicon-bonded hydroxyl or alkoxy group per molecule thereof and in which at least 10% by mole of the silicon-bonded monovalent hydrocarbon groups (R) are substituted or unsubstituted aromatic hydrocarbon groups.

In the formula (3), examples of unsaturated monovalent hydrocarbon group of the substituted or unsubstituted, saturated monovalent hydrocarbon groups having 1 to 18 carbon atoms represented by R specifically include linear or branched alkyl groups such as methyl, ethyl, propyl, isopropyl, n-butyl, isobutyl, t-butyl, pentyl, isopentyl, hexyl, isohexyl, heptyl, isoheptyl, octyl, isooctyl, nonyl, and decyl groups, cycloalkyl groups such as cyclopentyl, cyclohexyl, cyclooctyl, dicyclopentyl, and decahydronaphthyl groups, and aromatic groups such as aryl groups, e.g., phenyl, naphthyl, tetrahydronaphthyl, tolyl, and ethylphenyl groups, and aralkyl groups e.g., benzyl, phenylethyl, phenylpropyl, and methylbenzyl groups.

On the other hand, examples of substituted saturated monovalent hydrocarbon group represented by R in the formula (3) specifically include hydrocarbon groups in which part or all of the hydrogen atoms have been replaced by a halogen atom, cyano group, amino group, epoxy group, and the like. Specific examples thereof include substituted hydrocarbon groups such as chloromethyl, 2-bromoethyl, 3,3,3-trifluoropropyl, 3-chloropropyl, chloropheyl, dibromophenyl, difluorophenyl, β-cyanoethyl, γ-cyanopropyl, and β-cyanopropyl groups.

From the standpoint of affinity for the epoxy group-containing siloxane compound [ingredient (A)] described above and the properties of the thermosetting resin composition to be obtained, the organosiloxane [ingredient (C)] is one in which R in the formula (3) preferably is an alkyl group or an aryl group. When R is an alkyl group, more preferred alkyl groups are those having 1 to 3 carbon atoms which were shown above as examples. Especially preferred is a methyl group. An especially preferred aryl group is a phenyl group. In each siloxane unit or in the siloxane units, the groups represented by R in the formula (3) may be the same or different.

It is preferred in the organosiloxane [ingredient (C)] that at least 10% by mole of the silicon-bonded monovalent hydrocarbon group (R) in the structure represented by the formula (3) should be selected from aromatic hydrocarbon groups. The reason for this is as follows. In the case where the amount of aromatic hydrocarbon groups is too small, the organosiloxane has an insufficient affinity for epoxy resins, so that an opaque resin composition is obtained when the organosiloxane is dissolved or dispersed in the epoxy group-containing siloxane compound and the resin composition tends to give a cured material of the thermosetting resin composition to be obtained, which does not bring about sufficient effects with respect to light degradation resistance and physical properties. The content of such aromatic hydrocarbon groups is more preferably 30% by mole or higher, especially preferably 40% by mole or higher. The upper limit of the content of the aromatic hydrocarbon groups is 100% by mole.

The (OR¹) in the formula (3) is a hydroxyl group or an alkoxy group. When the (OR¹) is an alkoxy group, examples of R¹ include the alkyl groups having 1 to 6 carbon atoms which were enumerated above as examples of the R described above. More specifically, examples of R¹ include methyl, ethyl and isopropyl groups. In each siloxane unit or in the siloxane units, the groups represented by these groups may be the same or different.

It is preferred that the organosiloxane [ingredient (C)] should have at least one silicon-bonded hydroxyl or alkoxy group per one molecule thereof, that is, the organosiloxane should have an (OR¹) group of the formula (3) in at least one of the siloxane units constituting the organosiloxane. The reason for this is as follows. In the case where the organosiloxane has neither the hydroxyl group nor the alkoxy group, this organosiloxane has an insufficient affinity for epoxy resins. Furthermore, the thermosetting resin composition obtained is less apt to give a cured material having sufficient physical properties, probably because the hydroxyl group or alkoxy groups perform some function in the curing reaction of the epoxy resin although the mechanism thereof is unclear. The amount of the silicon-bonded hydroxyl or alkoxy groups in the organosiloxane [ingredient (C)] is preferably set so as to be in the range of 0.1 to 15% by weight in terms of OH group amount, and is more preferably 1 to 10% by weight. The reason for this is as follows. In the case where the amount of the hydroxyl groups or alkoxy groups is outside the range, the organosiloxane has a poor affinity for the epoxy group-containing siloxane compound [ingredient (A)]. Especially, when the amount thereof is too large (for example, exceeds 15% by weight), there is the possibility that a self-dehydration reaction or an alcohol elimination reaction might occur.

In the formula (3), m and n, which indicate each the number of repetitions, are each an integer of 0 to 3. The numbers m and n, which indicate each the number of repetitions, differ from siloxane unit to siloxane unit. The siloxane units constituting the organosiloxane are explained in greater detail. The units include units A1 to A4 represented by the following general formulae (4) to (7).

Unit A1:(R)₃SiO_{1/2} (4)

Unit A2:(R)₂(OR¹)ₙSiO_{(2-n)/2} (5)

In the formula (5), n is 0 or 1.

Unit A3:(R)(OR¹)ₙSiO_{(3-n)/2} (6)

In the formula (6), n is 0, 1, or 2.

Unit A4:(OR¹)ₙSiO_{(4-n)/2} (7)

In the formula (7), n is an integer of 0 to 3.

In the formulae (4) to (7), R is a substituted or unsubstituted, saturated monovalent hydrocarbon group having 1 to 18 carbon atoms, and Rs may be the same or different. R¹ may be a hydrogen atom or an alkyl group having 1 to 6 carbon atoms and R¹ s may be the same or different.

Namely, the siloxane units are classified according to m of the formula (3): the case where m=3 corresponds to unit A1, which is represented by the formula (4); the case where m=2 corresponds to unit A2, which is represented by the formula (5); the case where m=1 corresponds to unit A3, which is represented by the formula (6); and the case where m=0 corresponds to unit A4, which is represented by the formula (7). Of these units, unit A1, which is represented by the formula (4), is a structural unit which has only one siloxane bond and constitutes a terminal group. Unit A2, which is represented by the formula (5), is a structural unit which, when n is 0, has two siloxane bonds and constitutes linear siloxane bonds. When n in unit A3, which is represented by the formula (6), is 0 and when n in unit A4, which is represented by the formula (7), is 0 or 1, then each unit is a structural unit which can have three or four siloxane bonds and contributes to a branched structure or a crosslinked structure.

In the organosiloxane [ingredient (C)], it is preferred that the proportions of units A1 to A4, which are respectively represented by the formulae (4) to (7), should have been set as shown below under (a) to (d).

(a) unit A1: 0 to 30% by mole

(b) unit A2: 0 to 80% by mole

(c) unit A3: 20 to 100% by mole

(d) unit A4: 0 to 30% by mole

It is more preferred that the proportions of unit A1 and unit A4 should be 0% by mole, the proportion of unit A2 should be 5 to 70% by mole, and the proportion of unit A3 should be 30 to 100% by mole. Such proportion ranges are more preferred because by setting the proportions of unit A1 to A4 so as to be within those ranges, the effect of being capable of imparting (maintaining) moderate hardness and an appropriate modulus of elasticity to the cured material is obtained.

The organosiloxane [ingredient (C)] is constituted of those constituent units combined to one another or in a row. The polymerization degree of the siloxane unit is preferably in the range of 6 to 10,000. The state of the organosiloxane [ingredient (C)] depends on the polymerization degree and the crosslinking degree, and may be either liquid or solid.

The organosiloxane having such siloxane units represented by the formula (3) can be produced as follows. For example, the organosiloxane is obtained by subjecting at least one of an organosilane and an organosiloxane to a reaction, for example, hydrolysis in the presence of a solvent, e.g., toluene. In particular, a method in general use is to subject an organochlorosiloxane or an organoalkoxysiloxane to hydrolysis/condensation. The “organo” group is a group corresponding to the R in the formula (3), such as an alkyl group or an aryl group. Units A1 to A4, which are represented by the formulae (4) to (7), respectively correlate with the structures of the silanes used as starting materials. For example, in the case of chlorosilanes, use of a triorganochlorosilane gives unit A1, which is represented by the formula (4), use of a diorganochlorosilane gives unit A2, which is represented by the formula (5), use of a organochlorosilane gives unit A3, which is represented by the formula (6), and use of a tetrachlorosilane gives unit A4, which is represented by the formula (7). In the formulae (3) and (5) to (7), the silicon-bonded substituents represented by (OR¹) are hydrolysis residual groups remaining uncondensed.

In the case where the organosiloxane [ingredient (C)] is solid at ordinary temperature, the softening point (pour point) thereof is preferably 150° C. or lower, especially preferably 120° C. or lower, from the standpoint of melt-mixability with the thermosetting resin composition.

It is preferred that the content of the organosiloxane [ingredient (C)] should be set so as to be in the range of 5 to 60% by weight based on the whole thermosetting resin composition. Especially preferably, the content thereof is in the range of 10 to 40% by weight in view of the fact that the organosiloxane heightens the linear expansion coefficient of the composition. The reason for this is as follows. In the case where the content of the ingredient (C) is too low, there is a tendency that heat resistance and light degradation residence decrease. In the case where the content of the ingredient (C) is too high, there is a tendency that the resultant thermosetting resin composition gives a cured material which itself is considerably brittle.

Examples of the curing accelerator [ingredient (D)] to be used in combination with the above ingredients (A) to (C) include tertiary amines such as 1,8-diaza-bicyclo[5.4.0]undecene-7, triethylenediamine, tri-2,4,6-dimethylaminomethylphenol, and N,N-dimethylbenzylamine, imidazoles such as 2-ethyl-4-methylimidazole and 2-methylimidazole, phosphorus compounds such as triphenylphosphine, tetraphenylphosphonium tetraphenylborate, and tetra-n-butylphosphonium-o,o-diethylphosphoronedithioate, quaternary ammonium salts, organic metallic salts, and derivatives thereof. These may be used alone or in combination of two or more thereof. Among these curing accelerators, it is preferred to use octylic acid salts, sulfonium salts, or the like of tertiary amines such as N,N-dimethylbenzylamine and tri-2,4,6-dimethylaminomethylphenol.

It is preferred that the content of the curing accelerator [ingredient (D)] should be set at 0.01 to 8.0 parts by weight based on 100 parts by weight of the epoxy group-containing ingredient containing the epoxy group-containing siloxane compound [ingredient (A)]. More preferably, the content thereof is 0.1 to 3.0 parts by weight. The reason for this is as follows. When the content of the curing accelerator is too small, there are cases where a sufficient curing-accelerating effect is not obtained. When the content of the curing accelerator is too large, there is a tendency that discoloration is observed in the resultant cured material.

In the thermosetting resin composition of the invention, an epoxy resin having two or more epoxy groups in one molecule thereof [ingredient (E)] other than the above ingredient (A) can be used in addition to the ingredients (A) to (D). By thus using the epoxy resin [ingredient (E)] in combination, it becomes possible to easily control the reactivity with the curing agent and also to easily control glass transition temperature (Tg) and elastic modulus of the resultant cured material.

Examples of the epoxy resin [ingredient (E)] include novolak-type epoxy resins such as bisphenol A-type epoxy resins, bisphenol F-type epoxy resins, phenol novolak-type epoxy resins, and cresol novolak-type epoxy resins, alicyclic epoxy resins, nitrogen-containing ring epoxy resins such as triglycidyl isocyanurate and hydantoin epoxy resins, hydrogenated bisphenol A-type epoxy resins, aliphatic epoxy resins, glycidyl ether-type epoxy resins, bisphenol S-type epoxy resin, biphenyl-type epoxy resins which are mainstream of low water absorptive curing type ones, dicyclo ring-type epoxy resins, and naphthalene-type epoxy resins. These may be used alone or in combination of two or more thereof. Among these epoxy resins, from the standpoint of excellency in transparency and discoloration resistance of the cured material and melt-mixability with the aforementioned epoxy group-containing siloxane compound [ingredient (A)], it is preferred to use an alicyclic epoxy resin (e.g., Celoxide 2021P or Celloxide 2081 manufactured by Daicel Chemical Industries, Ltd.) or triglycidyl isocyanurate alone or in combination thereof.

The above epoxy resin [ingredient (E)] may be solid or liquid at ordinary temperature and, in general, an average epoxy equivalent of the epoxy resin to be used is preferably from 90 to 1000. In the case of solid one, the softening point is preferably 160° C. or lower. The reason for this is as follows. When the epoxy equivalent is too small, the cured material of the thermosetting resin composition sometimes becomes brittle. When the epoxy equivalent is too large, the glass transition temperature (Tg) of the cured material tends to become low in some cases.

The proportion of the above epoxy resin [ingredient (E)] is set in accordance with the above proportions of the epoxy group-containing siloxane compound [ingredient (A)] to the acid anhydride curing agent [ingredient (B)], and the proportion is preferably set so that an active group (an acid anhydride group or a hydroxyl group) capable of reacting with an epoxy group in the acid anhydride curing agent [ingredient (B)] is 0.5 to 1.5 equivalents, more preferably from 0.7 to 1.2 equivalents, per one equivalent of the epoxy resin in the thermosetting resin composition containing the above epoxy resin [ingredient (E)] in addition to the epoxy group-containing siloxane compound [ingredient (A)].

Moreover, of the total amount of the above epoxy resin [ingredient (E)] and the above epoxy group-containing siloxane compound [ingredient (A)], the proportion of the epoxy resin [ingredient (E)] is preferably set at 75% by weight or less, particularly preferably 50% by weight or less. The reasons for this are as follows. In the case where the proportion of the epoxy resin [ingredient (E)] is too large, there is observed a tendency that reflow-cracking resistance is poor.

The thermosetting resin composition of the invention may suitably contain, in addition to the above ingredients (A) to (D), various additives such as a deterioration inhibitor, a modifier, a defoaming agent, a leveling agent, a releasing agent, a dye, and the like, if necessary.

Examples of the deterioration inhibitor include deterioration inhibitors such as phenol compounds, amine compounds, organic sulfur compounds, and phosphine compounds. Examples of the modifiers include various modifiers such as glycols including ethylene glycol, silicones, and alcohols. Examples of the defoaming agent include various defoaming agents such as silicones.

Furthermore, the thermosetting resin composition of the invention further contains various inorganic fillers such as silica powders, glass flits, titanium oxide, and pigments, if necessary.

Moreover, in the case where the optical-semiconductor device in the invention is a light-emitting device which emits light having a wavelength ranging ultraviolet to blue color, it becomes possible to form a white-color emitting device by dispersing a phosphor as a wavelength converting material into the thermosetting resin composition or by placing the phosphor in the vicinity of a light-emitting element.

The thermosetting resin composition of the invention can be obtained in the form of liquid, powder or a tablet formed through tabletting from the powder, by preparing the composition in the following manner, for example. That is, in order to obtain a liquid thermosetting resin composition, for example, the above-described ingredients, i.e., the above ingredients (A) to (D), moreover, ingredient (E), and various additives to be blended as needed, may be appropriately blended. Moreover, in order to obtain the resin composition in the form of powder or a tablet formed through tabletting from the powder, for example, the above ingredients are appropriately blended and preliminarily mixed, followed by kneading and melt-mixing the resulting mixture using a kneader. Subsequently, a powdery thermosetting resin composition can be prepared by cooling the resulting mixture to room temperature and then pulverizing the cooled product after being subjected to an aging process. If necessary, it is possible to form a tablet by tabletting the above powdery thermosetting resin composition.

The thermosetting resin composition of the invention thus obtained is used as an encapsulating material for optical-semiconductor elements such as light-emitting diodes (LED), various sensors, and charge-coupled devices (CCD), and as a forming member for optical-semiconductor devices, such as a material for forming reflection plates including white reflectors. That is, encapsulation of an optical-semiconductor element using the thermosetting resin composition of the invention can be carried out by a method for encapsulating optical-semiconductor elements, such as transfer molding or injection molding, potting, coating, or casting. When the thermosetting resin composition of the invention is liquid, the thermosetting resin composition may be used as the so-called two-liquid type such that at least the epoxy resin and the curing accelerator are stored separately and mixed immediately before use. When the thermosetting resin composition of the invention is in the form of powder or tablet after being subjected to a predetermined aging process, the above ingredients are provided in the state of “B stage” (semi-cured state) upon melting and mixing of the ingredients, and this product may be heated and melted upon use.

The optical-semiconductor device using the thermosetting resin composition of the invention can be produced by resin-encapsulation of an optical-semiconductor element as mentioned above. Examples of the molding conditions (curing conditions for the thermosetting resin composition) include conditions composed of heat-curing at 130 to 180° C. for 2 to 8 minutes and subsequent post-curing at 130 to 180° C. for 1 to 5 hours.

### EXAMPLES

Examples are given below together with Comparative Examples. However, the invention should not be construed as being limited to the following Examples.

First, prior to the production of resin compositions, the ingredients shown below were prepared or produced.

Epoxy Resin a: 1,3,5-trisglycidyl isocyanurate (epoxy equivalent: 100 g/eq, melting point: 100° C.)

Epoxy Resin b: an adduct of 2,2-bis(hydroxymethyl)-1-butanol to 1,2-epoxy-4-(2-oxiranyl)cyclohexane (epoxy equivalent: 185 g/eq, softening point: 85° C.)

Acid anhydride: methylhexahydrophthalic anhydride (acid equivalent: 168 g/eq)

Curing Accelerator: N,N-demethylbenzylamine

Polyorganosiloxane:

Into a flask were introduced 206 g (50 mol %) of phenyltrimethoxysilane and 126 g (50 mol %) of dimethyldimethoxysilane. A mixture of 1.2 g of 20% aqueous HCl solution and 40 g of water was added dropwise thereto. After completion of the dropwise addition, refluxing was continued for 1 hour. Subsequently, the resultant solution was cooled to room temperature (25° C.) and then neutralized with sodium hydrogen carbonate. The organosiloxane solution obtained was filtered to remove impurities, and low-boiling substances were then distilled off at a reduced pressure using a rotary evaporator to thereby obtain a liquid polyorganosiloxane. The polyorganosiloxane obtained had a softening point of 59° C. and a hydroxyl group concentration of 5.1 mol %. Furthermore, the polyorganosiloxane obtained was constituted of 50 mol % of the units A2 and 50 mol % of the units A3, and contained 33% of phenyl groups and 67% of methyl groups, and OH groups and alkoxy groups in an amount of 9% by weight in terms of OH group.

Epoxy Group-Containing Siloxane Compound: EDMS-1

Into a 1 L four-neck separable flask fitted with a thermometer, a cooling tube, a nitrogen inlet tube, and a stirring blade were introduced 184 parts by weight of a polysiloxane (Si—H equivalent: 363 g/eq) having a terminal Si—H group represented by the general formula (2) in which an average value of n is 8 and R₁ is a methyl group, 250 parts by weight of dioxane, and 0.27 part by weight of a platinum catalyst supported on carbon powder (platinum concentration: 5%). Subsequently, the inner temperature was elevated to 90° C. and then 150 parts by weight of N-allyl-N′,N″-diglycidyl isocyanurate was introduced over a period of 3 hours. After completion of the introduction, the inner temperature was elevated to 110° C. and a reaction was carried out with refluxing dioxane. Then, the reaction liquid was added dropwise to a 0.1N potassium hydroxide/methanol solution and, after no generation of hydrogen gas was confirmed, the remaining platinum catalyst was filtrated through celite. Subsequently, by removing the solvent of the filtrated solution using an evaporator, 320 parts by weight of an epoxy group-containing siloxane compound (EDMS-1) was obtained. The epoxy group-containing siloxane compound was an epoxy group-containing siloxane compound of the general formula (1) in which R₁ is a methyl group, R₂ is a propylene group, and an average value of n is 8, which had an epoxy equivalent of 317 g/eq and a viscosity at 25° C. of 4.5 Pa·s.

Epoxy Group-Containing Siloxane Compound: EDMS-2

Thirty-eight parts by weight of a polysiloxane (Si—H equivalent: 363 g/eq) having a terminal Si—H group represented by the general formula (2) wherein an average value of n is 4 and R₁ is a methyl group, 38 parts by weight of dioxane, 0.09 part by weight of a platinum catalyst supported on carbon powder (platinum concentration: 5%), and 50 parts by weight of N-allyl-N′,N″-diglycidyl isocyanurate were used. The same operation as in the case of the above EDMS-1 was performed except the above fact, thereby obtaining 81 parts by weight of an epoxy group-containing siloxane compound (EDMS-2). The epoxy group-containing siloxane compound was an epoxy group-containing siloxane compound of the general formula (1) in which R₁ is a methyl group, R₂ is a propylene group, and an average value of n is 4, which had an epoxy equivalent of 237 g/eq, a melting point of about 55° C., and a viscosity at 75° C. of 0.34 Pa·s.

Additive: Ethylene Glycol

### Examples 1 to 11 And Comparative Examples 1 to 4

The ingredients shown in Table 1 to Table 3 shown later were put together according to each of the formulations shown in the tables, and were melt-mixed in a beaker. Each mixture was aged, subsequently cooled to room temperature to be solidified, and pulverized. Thus, desired powdery epoxy resin compositions were produced.

Using each of the thermosetting resin compositions of Examples and Comparative Examples thus obtained, evaluation for various properties was performed by the following methods. The results thereof are also shown in Table 1 to Table 3 given later.

Measurement of Light Transmittance

Using each of the thermosetting resin compositions, test pieces having a thickness of 1 mm were produced under predetermined curing compositions (conditions: 150° C. for 3 hours). Using the test pieces (cured materials), the light transmittance was measured while the test pieces were immersed in liquid paraffin. As a measuring apparatus, a spectrophotometer UV3101 manufactured by Shimadzu Corporation was used and the light transmittance at a wavelength of 400 nm was measured at room temperature (25° C.).

Measurement of Glass Transition Temperature (Tg)

Using each of the thermosetting resin compositions, test pieces (cured materials) were produced under predetermined curing conditions (conditions: 150° C., 3 hours). Using 10 to 20 mg of the cured material, the glass transition temperature (Tg) was measured on a differential scanning calorimeter (manufactured by Perkin-Elmer, PYRIS 1) at a temperature-elevating rate of 10° C./min.

Measurement of Flexural Strength and Flexural Modulus/Deflection

Using each of the thermosetting resin compositions, test pieces having a width of 10 mm, a length of 100 mm, and a thickness of 4 mm under predetermined curing conditions (conditions: 150° C. for 3 hours). Using the test pieces (cured materials), the flexural strength and flexural modulus, and deflection were measured at a head speed of 5 mm/min at a distance between supporting points of 64 mm by an autograph (manufactured by Shimadzu Corporation, AG500C) at room temperature (25° C.) in accordance with JIS K6911.

Measurement of Thermal Expansion Coefficient

Using each of the above thermosetting resin compositions, columnar test pieces having a length of 15 mm and 5 mm square were produced under predetermined curing conditions (conditions: 150° C. for 3 hours). Using the test pieces (cured materials), thermal expansion was measured at a temperature-elevating rate of 2° C./min and a thermal expansion rate at 40 to 70° C. was taken as a thermal expansion coefficient.

Measurement of Light Resistance Life

Using each of the above epoxy resin compositions, test pieces having a thickness of 1 mm were produced under predetermined curing conditions (conditions: 150° C. for 3 hours). The test pieces (cured materials) were irradiated using a 405 nm short-wavelength laser (NDHV310APC, manufactured by Nichia Kagaku Kogyo K.K.) under the conditions of 25 mW and 20 μm (80 W/mm²). The light obtained by transmittance through each cured material was received with a power meter (OP-2VIS, manufactured by Coherent Inc.) to measure the intensity of the light. The time period required for the intensity of the received light to decrease to 50% of the initial value thereof was measured and the measurement results were taken as light resistance life.

Reflow-Cracking Resistance

A printed wiring board [material: FR-4 (copper-clad laminate glass epoxy board), size: 82 mm×82 mm, thickness: 0.8 mm] and a silicon chip (size: 3 mm×3 mm, thickness: 0.37 mm) were prepared. Using a die-bonding agent (manufactured by Hitachi Chemical Co., Ltd., EN-4000), 16 silicon chips in total were placed on each area of 4 by 4 grids of the printed wiring board (16 areas in total).

Thereafter, the die-bonding agent was thermally cured by heating at 150° C. for 3 hours and then resin-encapsulation (encapsulating resin part: 30 mm×30 mm, thickness 1.0 mm) was performed by injection molding of each of the above thermosetting resin compositions at 150° C. for 3 minutes by a molding machine. Subsequently, post-curing was performed at 150° C. for 3 hours and then the board was cut into square individual packages having a size of 20 mm×20 mm using a dicer. The individual packages obtained was allowed to stand in a heating and moisturizing furnace at 30° C./70% relative humidity for 96 hours and then reflow-cracking resistance was evaluated under JEDEC reflow conditions at 260° C. For the evaluation, one on which no crack was confirmed in all 16 areas was indicated as “good” and one on which a crack was confirmed in even one area among the 16 areas was indicated as “poor”.

TABLE 1
(parts by weight)

| | Example | | | | | | |
|---|---|---|---|---|---|---|---|
| | 1 | 2 | 3 | 4 | 5 | 6 | 7 |
| Epoxy resin a | — | — | — | — | 50 | 50 | 50 |
| Epoxy resin b | — | — | — | — | — | — | — |
| EDMS-1 | 100 | 100 | — | 100 | 50 | 50 | 50 |
| EDMS-2 | — | — | 100 | — | — | — | — |
| Acid anhydride curing agent | 70.9 | 70.9 | 53.0 | 70.9 | 108 | 108 | 108 |
| Polyorganosiloxane | 19.1 | 42.9 | 17.1 | 74.0 | 23.2 | 52.0 | 89.0 |
| Ethylene glycol | — | — | — | — | 3.0 | 3.0 | 3.0 |
| Curing accelerator | 0.5 | 0.5 | 0.5 | 0.5 | 0.5 | 0.5 | 0.5 |
| Glass transition temperature | 136 | 122 | 117 | 101 | 167 | 151 | 142 |
| (Tg) (° C.) | | | | | | | |
| Thermal expansion | 123 | 129 | 159 | 136 | 79 | 85 | 91 |
| coefficient (ppm/k) | | | | | | | |
| Flexural modulus (MN/m²) | 2.2 × 10³ | 2.4 × 10³ | 1.3 × 10³ | 2.7 × 10³ | 2.7 × 10³ | 2.8 × 10³ | 3.0 × 10³ |
| Flexural strength (MN/m²) | 75 | 78 | 56 | 52 | 93 | 98 | 84 |
| Deflection (mm) | 11.6 | 10.2 | 12.7 | 3.2 | 9.7 | 7.8 | 5.9 |
| Light transmittance (%) | 92.2 | 90.3 | 91.4 | 91.8 | 92.8 | 95.4 | 96.7 |
| Light resistance life (min) | 468 | 1997 | 735 | 3976 | 383 | 544 | 1081 |
| Reflow-cracking resistance | good | good | good | good | good | good | good |

TABLE 2
(parts by weight)

| | Example | | | |
|---|---|---|---|---|
| | 8 | 9 | 10 | 11 |
| Epoxy resin a | 75 | 25 | 50 | — |
| Epoxy resin b | — | — | — | 50 |
| EDMS-1 | 25 | 75 | — | — |
| EDMS-2 | — | — | 50 | 50 |
| Acid anhydride curing | 129 | 85.4 | 99.5 | 86.9 |
| agent | | | | |
| Polyorganosiloxane | 57.5 | 20.6 | 22.3 | 46.8 |
| Ethylene glycol | 3.0 | 3.0 | 3.0 | 3.0 |
| Curing accelerator | 0.5 | 0.5 | 0.5 | 0.5 |
| Glass transition | 157 | 144 | 139 | 141 |
| temperature (Tg)(° C.) | | | | |
| Thermal expansion | 78 | 88 | 98 | 85 |
| coefficient (ppm/k) | | | | |
| Flexural modulus | 2.9 × 10³ | 2.6 × 10³ | 1.7 × 10³ | 2.8 × 10³ |
| (MN/m²) | | | | |
| Flexural strength | 91 | 93 | 56 | 82 |
| (MN/m²) | | | | |
| Deflection (mm) | 6.2 | 9.6 | 8.3 | 5.2 |
| Light transmittance (%) | 95.1 | 95.6 | 90.8 | 90.4 |
| Light resistance life | 412 | 688 | 897 | 289 |
| (min) | | | | |
| Reflow-cracking | good | good | good | good |
| resistance | | | | |

TABLE 3
(parts by weight)

| | Comparative Example | | | |
|---|---|---|---|---|
| | 1 | 2 | 3 | 4 |
| Epoxy resin a | — | — | 50 | 100 |
| Epoxy resin b | — | — | — | — |
| EDMS-1 | 100 | — | 50 | — |
| EDMS-2 | — | 100 | — | — |
| Acid anhydride curing | 70.9 | 53.0 | 108 | 168 |
| agent | | | | |
| Polyorganosiloxane | — | — | — | 67 |
| Ethylene glycol | — | — | 3.0 | 3.0 |
| Curing accelerator | 0.5 | 0.5 | 0.5 | 0.5 |
| Glass transition | 158 | 136 | 139 | 171 |
| temperature (Tg)(° C.) | | | | |
| Thermal expansion | 117 | 151 | 93 | 73 |
| coefficient (ppm/k) | | | | |
| Flexural modulus | 1.9 × 10³ | 1.9 × 10³ | 3.2 × 10³ | 3.5 × 10³ |
| (MN/m²) | | | | |
| Flexural strength | 72 | 49 | 108 | 72 |
| (MN/m²) | | | | |
| Deflection (mm) | 12.3 | 14.8 | 10.2 | 4.1 |
| Light transmittance (%) | 94.6 | 95.2 | 93.7 | 95.3 |
| Light resistance life | 53 | 187 | 42 | 317 |
| (min) | | | | |
| Reflow-cracking | good | good | good | bad |
| resistance | | | | |

The results given above show that all the Examples exhibit high light transmittance and are excellent in transparency, exhibit high flexural modulus and flexural strength and large deflection and hence are excellent in strength, and also exhibit long light resistance life and hence are excellent in light resistance. Furthermore, with regard to the reflow-cracking resistance, no crack was formed and excellent results were obtained.

On the other hand, Comparative Examples 1 to 3 in which an epoxy group-containing siloxane compound was used but any polyorganosiloxane was not used exhibit large deflection and exhibit short light resistance life and thus are inferior in light resistance. In Comparative Example 4, since a polyorganosiloxane was used but any epoxy group-containing siloxane compound was not used, a good result was obtained with regard to light resistance but a crack was formed in the evaluation of reflow-cracking resistance.

While the invention has been described in detail with reference to specific embodiments thereof, it will be apparent to one skilled in the art that various changes and modifications can be made therein without departing from the spirit and scope thereof.

Incidentally, the present application is based on Japanese Patent Application No. 2010-034131 filed on Feb. 18, 2010, and the contents are incorporated herein by reference.

All references cited herein are incorporated by reference herein in their entirety.

Also, all the references cited herein are incorporated as a whole.

The thermosetting resin composition of the invention is useful as an encapsulation material for optical-semiconductor elements such as light-emitting diodes (LED), various sensors, and charge-coupled devices (CCD) and also it is possible to use as a material for forming reflection plates such as reflectors of the above LED.

What is claimed is:

1. A thermosetting resin composition for optical-semiconductor element encapsulation, the thermosetting resin composition comprising the following ingredients (A) to (D):
(A) an epoxy group-containing siloxane compound represented by the following general formula (1): 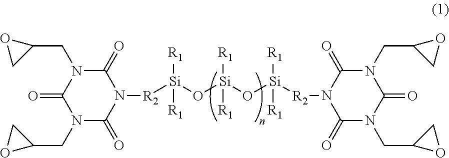
wherein R₁ is a monovalent hydrocarbon group having 1 to 10 carbon atoms, R₂ is a divalent hydrocarbon group having 1 to 20 carbon atoms and may contain an oxygen atom for ether formulation or ester formulation inside thereof, and n is an integer of 0 to 20;
(B) an acid anhydride curing agent;
(C) a thermally condensable organosiloxane; and
(D) a curing accelerator.

2. The thermosetting resin composition for optical-semiconductor element encapsulation according to claim 1, which further contains the following ingredient (E) in addition to the ingredients (A) to (D):
(E) an epoxy resin having two or more epoxy groups in one molecule thereof, other than the ingredient (A).

3. The thermosetting resin composition for optical-semiconductor element encapsulation according to claim 1, wherein a content of the ingredient (B) is set so that an amount of acid anhydride groups in the ingredient (B) is in the range of 0.5 to 1.5 equivalents per one equivalent of the epoxy groups in the whole thermosetting resin composition.

4. The thermosetting resin composition for optical-semiconductor element encapsulation according to claim 1, wherein the ingredient (C) is a polyorganosiloxane represented by the following general formula (3):
Rₘ(OR¹)ₙSiO_{(4-m-n)/2} (3)
wherein R is a substituted or unsubstituted, saturated monovalent hydrocarbon group having 1 to 18 carbon atoms and R¹ may be the same or different, R¹ is a hydrogen atom or an alkyl group having 1 to 6 carbon atoms and R¹s may be the same or different, and m and n are each an integer of 0 to 3.

5. A cured material of the thermosetting resin composition for optical-semiconductor element encapsulation, the cured material being obtained by heat-curing the thermosetting resin composition for optical-semiconductor element encapsulation according to claim 1.

6. An optical-semiconductor device obtained by resin-encapsulating an optical-semiconductor element using the thermosetting resin composition for optical-semiconductor element encapsulation according to claim 1.

7. An optical-semiconductor device obtained by resin-encapsulating an optical-semiconductor element using the cured material of the thermosetting resin composition for optical-semiconductor element encapsulation according to claim 5.
